(19) United States
(12) Patent Application Publication
(10) Pub. No.: US 2005/0109260 A1
(43) Pub. Date: May 26, 2005

(54) Light-reflective path-marking apparatus

(76) Inventor: John D. Wydner, Danville, AL (US)

Correspondence Address: LANIER FORD SHAVER & PAYNE, P O BOX 2087, HUNTSVILLE, AL, 35804, US

(21) Appl. No.: 10/720,493

(22) Filed: Nov. 24, 2003

(51) Int. Cl. G01D 21/00

(52) U.S. Cl. 116/209

(57) ABSTRACT

A unitary light-reflective path-marking apparatus is provided. Such apparatus comprises two extension arms with an integral tensioned connecting member therebetween. Each extension arm has an internal and external surface. The internal surfaces of each extension arm have a specialized shape for enhancing the function of the apparatus. Each external surface of the extension arms may have a specialized treatment for enhancing the ease of use of the apparatus. The apparatus may be formed using a plastic or a metal and may be colored through a variety of techniques for ease of detection during both daylight and evening use. The light-reflective characteristic of the present apparatus may be achieved through the use of light-reflective paint, tape, or materials adhered to the outer surfaces of the unitary clip member. The apparatus may be removably attached to various floras along a path taken by the use for use in indicating the reverse path back to the point of origin of any excursion into an unknown or unfamiliar outdoor area.

### BACKGROUND OF THE INVENTION

This invention generally relates to outdoor equipment. In particular, the present invention relates to hunting and hiking equipment. More particularly, the present invention relates to an apparatus useful for marking a path taken by a user so as to permanently or temporarily indicate such path either to the user or others.

When hunters, hikers or others seek to provide landmarks of their chosen path they often use conventionally known markers. Numerous conventional markers are known including colored “flags” tied to branches or simple markings on tree trunks, such as by chalk or other marker. These conventional markers however suffer from the inability to remain effective either at night or in bad weather.

To overcome these limitations, tacks and other markers have been used. The tacks are stuck into trees along the path and are treated with a reflective coating or tape over the head of the tack. The tack, however, is difficult to locate during the day because the reflective material is generally not bright enough. At night, the size of the tack is often such that the reflective portion is too small to easily be found.

Additionally, the prior art tacks are extremely difficult to drive into and/or to remove from the trees. As such, users tend to leave the tacks in the trees resulting in potential confusion between “new” and “old” path markers, as well as, requiring the user to continuously purchase new markers/tacks. As with nails, the tacks also generate a potential hazard to both humans and machines involved in harvesting trees and cutting such logs at saw mills. It is, therefore, desirable to provide a cost-efficient reusable marker of sufficient size that is ecologically safe if left in the outdoors.

### SUMMARY OF THE INVENTION

The present invention recognizes and addresses various of the foregoing limitations and drawbacks, and others, concerning path-marking apparatus. Therefore, the present invention is directed to a unitary reusable light-reflective path-marking clip.

As such, it is a principle object of the subject invention to provide a safety device for use by hunters, hikers, bird watchers, etc. to aid in preventing getting lost in the woods. More particularly, it is an object of the present invention to provide an easy to use light-reflective path-marking apparatus. In such context, it is still a more particular object of the present invention to provide such a light-reflective path-marking apparatus that is effective in both day and nighttime conditions.

Further, it is a principle object of this invention to provide a path-marking apparatus that is unitary in construction and thus cost effective in its manufacture. It is a further object of the present invention to provide reusable path-marking apparatus. In such context, it is an object of the present invention to provide a unitary light-reflective path-marking clip member of metal or plastic construction.

Still further, it is a principle object of the present invention to provide a path-marking apparatus that utilizes a light-reflective methodology independent of the material composition of the apparatus. In such context, it is an object of the present invention to provide a light-reflective path-marking apparatus that utilizes either light reflective paint, tape or material adhered to the preformed unitary clip member of the present invention.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

In one exemplary embodiment, there may be provided a unitary light-reflective marker that can be removably attached to various objects such as tree branches, briar bushes, weed grasses, etc., to mark a path through woods or thickets to enable hunters, bird watchers, hikers, campers, and others, to find their way in and out of the woods. The apparatus of the present invention is reliable, easy to use, reusable, and durable in all weather, long lasting, environmentally safe and economical.

The light-reflective marker may consist of a single unitary, metal or plastic clip member with two extension arms joined by an integral tensioned member. The unitary clip member may be manufactured using any of the known methods of handling metal or plastics, including but not limited to press or injection molding.

The unitary clip member may further include a reflective surface treatment, member or tape on at least one surface of the unitary clip member. An exemplary embodiment of the present invention may include either a reflective paint or a reflective tape on at least one surface of the unitary clip member. Another exemplary embodiment of the present invention may include a reflective sticker adhered on the unitary clip member to limited specific areas on one or both of the extension arms thereof.

Further still, the present invention may be formed so as to enhance their daytime visibility through the use of brightly colored paint colors such as, but not limited to, “hunter's orange.” To enhance the unitary clip member's ability to grasp a small tree branch, bush, or stalk of weed grass, each extension arm may be provided with an exaggerated serrated edge on their adjacent edges. Finally, to enhance the ease of use the unitary clip member, the outer or opposing edges of the extension arms may include a textured surface treatment for easier handling during poor weather or other adverse conditions.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of one embodiment of the present invention;

FIG. 2 is a side view of the exemplary embodiment of the present invention as illustrated in FIG. 1;

FIG. 3 is a top view of the exemplary embodiment of the present invention as illustrated in FIGS. 1 and 2; and

FIG. 4 is a side view of an alternative embodiment of the present invention.

Repeated use of reference characters throughout the present specification and appended drawings is intended to represent the same or analogous features or elements of the same or different embodiments of the present invention.

### DETAILED DESCRIPTION OF THE PREFERRED EMBODIMENTS

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

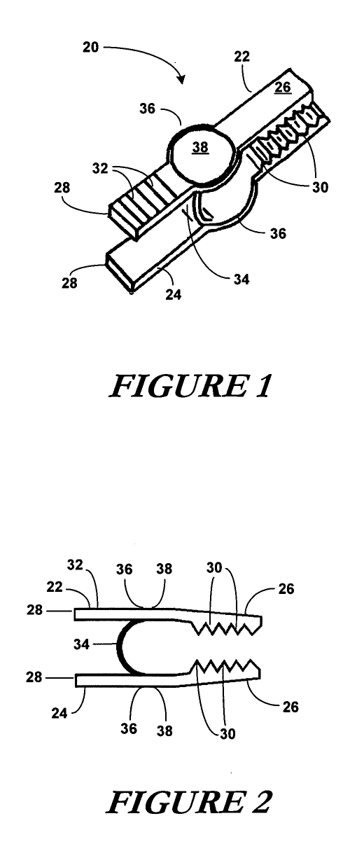

As disclosed above, the present invention is particularly concerned with a light-reflective path-marking apparatus. As seen in FIG. 1, the present invention comprises a unitary clip member 20 comprising two extension arms 22 and 24. Each extension arm 22 and 24 has an engagement end 26 and a remote end 28. The engagement end 26 of each extension arm 22 and 24 has an inner surface treatment 30 for enhancing the clip member's grasping capability when engaged on a tree branch, bush or weed grass stalk. Such treatment 30 may be, but is not limited to, an exaggerated serrated surface 30 or as depicted in FIG. 4 a scalloped edge 40. Similarly, remote end 28 of each extension arm 22 and 24 has an outer surface treatment 32 to enhance the ease of use during bad weather or in darkness. Such remote end 28 surface treatment 32 may be, but is not limited to, a raised textured surface 32 to enhance frictional interaction between a user's hand and the outer surface of the apparatus 20.

As depicted in FIG. 2 the extension arms 22 and 24 are joined by an integrally formed tensioned member 34. Such tensioned member 34 is curvilinear in shape to allow for sufficient flexing to enable said clip member 20 to open and/or separate the engagement ends 26 of both extension arms 22 and 24. The tension member 34 is located generally about two-thirds the length of the clip member 20 from the engagement end 26 of the extension arms 22 and 24.

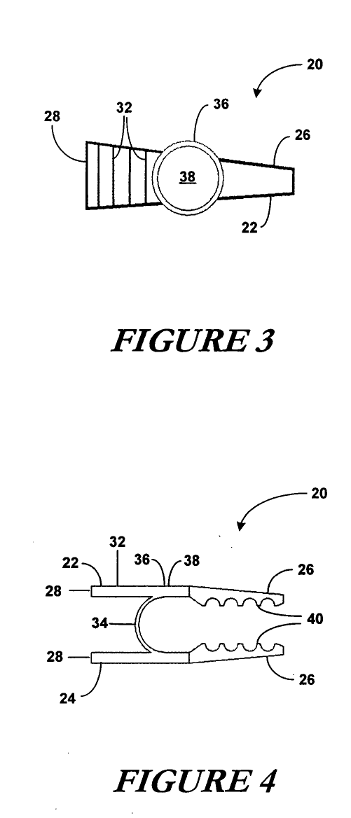

FIG. 3 depicts a top view of extension arm 22 with the engagement end 26 to the right and the remote end 28 to the left. On the outer surface of the remote end 28 of the extension arm 22 is shown a textured surface treatment 32. Generally centered along the length of each extension arm 22 and 24 is located a generally flat, generally circular receiving surface 36 larger in diameter than the width of the extension arms 22 and 24. In the embodiment shown of the present invention, a generally circular reflective tape sticker 38 is placed on the outer surfaces of each extension arm 22 and 24 on the generally circular receiving surface 36. It is this reflective tape sticker 38 that aid in serving to indicate the position of the path-marking apparatus 20 during both daytime and nocturnal use of the apparatus 20.

Alternatively, the path-marking apparatus 20 may be coated in a light reflective paint or have a portion of such apparatus 20 made of light reflective material. While the clip member 20 may be of any suitable material, a plastic or metal form would allow for the greatest ease of use, ecological suitability and overall durability. The clip member 20 may be made using any of the known techniques of material handling, including but not limited to, press or injection molding for either a plastic or metal material, as well as, metal casting.

Although a preferred embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred version contained herein.

1. A path-marking apparatus comprising:
a single unitary clip member having two extension arms connected by an integral tensioned member therebetween; and
wherein on an outer surface of each of said extension arms is a light-reflective tape sticker.

2. The path-marking apparatus of claim 1, wherein said apparatus further comprises a light-reflective material.

3. The path-marking apparatus of claim 1, wherein said light-reflective material is paint.

4. The path-marking apparatus of claim 1, wherein each of said extension arms has an engaging end and a remote end and wherein an interior surface of each of said engaging ends of each of said extension arms has a surface treatment for enhancing the frictional interaction between said apparatus and its point of attachment.

5. The path-marking apparatus of claim 4, wherein said surface treatment is an exaggerated serrated edge.

6. The path-marking apparatus of claim 4, wherein said surface treatment is a scalloped edge.

7. The path-marking apparatus of claim 4, wherein an exterior surface of each of said remote ends of each of said extension arms has a surface treatment for enhancing the frictional interaction between said apparatus and a user to enhance bad weather and nighttime use of the apparatus.

8. The path-marking apparatus of claim 7, wherein said surface treatment on said outer surface of each of said remote ends of each of said extension arms is a raised textured surface.

9. The path-marking apparatus of claim 4, wherein said integral tension member is curvilinear so as to allow for sufficient flexing of said integral tensioned member to enable said apparatus to separate said engagement ends of said extension arms when said remote ends of said extension arms are forced toward one another.

10. A path-marking apparatus comprising:
an integrally formed unitary clip member having two extension arms connected by a tensioned member therebetween;
wherein each of said extension arms has an engagement end and a remote end and an outer surface and an inner surface;
wherein said tensioned member is located generally along said apparatus about two-thirds of the distance from said engagement end to said remote end from said engagement end; and
wherein said path-marking apparatus is provided with a light-reflective tape sticker.

11. The path-marking apparatus of claim 10, wherein said apparatus comprises a light-reflective material.

12. The path-marking apparatus of claim 10, wherein said light reflective tape is present on said outer surfaces of each of said extension arms of said apparatus.

13. (canceled)

14. The path-marking apparatus of claim 11, wherein said light-reflective material is paint.

15. The path-marking apparatus of claim 10, wherein said interior surface of each of said extension arms at their respective engagement ends has a surface treatment for enhancing the frictional interaction between said apparatus and its point of attachment.

16. The path-marking apparatus of claim 15, wherein said surface treatment is an exaggerated serrated edge.

17. The path-marking apparatus of claim 15, wherein said surface treatment is a scalloped edge.

18. The path-marking apparatus of claim 10, wherein said apparatus is made of plastic.

19. The path-marking apparatus of claim 18, wherein said plastic includes an orange pigment to enhance the daytime visibility of the apparatus.

20. The path-marking apparatus of claim 18, wherein said plastic is painted with a light-reflective paint.

21. The path-marking apparatus of claim 10, wherein said apparatus is made of metal.

22. The path-marking apparatus of claim 21, wherein said apparatus is painted orange to enhance its daytime visibility.

23. The path-marking apparatus of claim 22, wherein said paint is light reflective.

24. A light reflective path-marking apparatus, comprising:
an integrally formed clip member having two extension arms connected by a tensioned member therebetween;
wherein each of said extension arms has a surface treatment on both their opposed surfaces and their adjacent surfaces and wherein the surface treatments on the adjacent surfaces cover only about one-half of each of said extension arm's length;
wherein said clip member is provided with a capability during its manufacture to reflect light thus better indicating its presence to a user during night time and wherein said capability is provided by a light reflective tape sticker adhered generally to the center of the opposing surfaces of each of said extension arms; and
wherein said clip member is orange to better indicate its presence during day time use.
